(19) United States
(12) Patent Application Publication
(10) Pub. No.: US 2004/0075181 A1
(43) Pub. Date: Apr. 22, 2004

(54) Thermal transport apparatus and method for manufacturing the same

(75) Inventor: Masaki Hara, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 10/628,366

(22) Filed: Jul. 29, 2003

(30) Foreign Application Priority Data
Aug. 20, 2002 (JP) 2002-239373

(51) Int. Cl. B01D 47/16

(52) U.S. Cl. 261/99

(57) ABSTRACT

The present invention provides a thermal transport apparatus capable of easily forming a wick, stably circulating a working fluid in the thermal transport apparatus and achieving a high efficiency of thermal transport, and a method for manufacturing the thermal transport apparatus. The liquid working fluid flowing through a liquid-phase path toward an evaporator wick communicating hole permeates into micro holes formed between grains which fill in the evaporator wick communicating hole, and flows into a wick of an evaporator. A vapor of the working fluid evaporating in the evaporator passes through a vapor-phase path and flows into a condenser through a condenser wick communicating hole. In the condenser, the working fluid is again liquefied. The liquefied working fluid flows through the liquid-phase path from the condenser to the evaporator wick communicating hole. In the evaporator wick communicating hole filled with the grains, a capillary force can be generated to stably circulate the working fluid in the thermal transport apparatus.

### BACKGROUND OF THE INVENTION

1. Field of the Invention

The present invention relates to a thermal transport apparatus having an evaporation part and a condensation part. Particularly, the present invention relates to a thermal transport apparatus such as a capillary pump loop, a loop heat pipe, or the like in the field of fluid MEMS (Micro-Electro-Mechanical Systems), and a method of manufacturing the same.

2. Description of the Related Art

FIG. 11 is an exploded perspective view showing an example of a thermal transport apparatus 100 proposed by the inventor. FIG. 11 shows flow directions of a working fluid by arrows. In the thermal transport apparatus 100, thermal transport is performed in the following system.

A liquid working fluid transported from a condenser 101 passes through a liquid-phase path 102, reaches an evaporator 103, and evaporates by external heat in the evaporator 103. A vapor of the working fluid moves at a high speed through a vapor-phase path 104 to the condenser 101 and releases heat to the outside of the condenser 101 to return to a liquid. A series of thermal transport steps is repeatedly performed in the thermal transport apparatus 100. In the thermal transport apparatus 100, a main driving force for moving the working fluid is a capillary force in a wick 105 provided in each of the evaporator 103 and the condenser 101.

In the series of thermal transport steps in the thermal transport apparatus 100, the working fluid which becomes a liquid in the condenser 101 passes through the liquid-phase path 102 and flows into the wick 105 of the evaporator 103 through an evaporator wick communicating hole 107 provided in a second substrate 106.

However, when the evaporator wick communicating hole 107 has a larger flow path area than the section of the liquid-phase path 102, the capillary force decreases at the time the working fluid flows into the evaporator wick communicating hole 107 from the liquid-phase path 102, thereby causing the problem of a difficulty in continuous movement of the working fluid. Furthermore, when a small thin thermal transport apparatus 100 is formed by bonding substrates together, there is the problem of a difficulty in filling the evaporator wick communicating hole 107 with a porous sintered metal or glass fiber which is used for, for example, generating a capillary force, in order to maintain the capillary force in the evaporator wick communicating hole 107.

Also, when the wick 105 has a complicated shape, there is the problem of a difficulty in forming the wick 105 by using a porous sintered metal or glass fiber.

### SUMMARY OF THE INVENTION

The present invention has been achieved for solving the above problems, and an object of the present invention is to provide a thermal transport apparatus capable of easily forming a capillary force generating portion in a flow path of a working fluid and in a wick, stably circulating the working fluid in the thermal transport apparatus, and achieving a high efficiency of thermal transport, and a method of manufacturing the thermal transport apparatus.

In order to achieve the object, a thermal transport apparatus of the present invention comprises a substrate having a flow path of a liquid-phase working fluid and a flow path of a vapor-phase working fluid, a wick member disposed on at least one main surface of the substrate, a communicating hole provided in the substrate for connecting the flow path of the liquid-phase working fluid of the substrate to the wick member, and grains filling in the communicating hole.

In the present invention, the communicating hole for the working fluid is filled with the grains to form a plurality of micro flow paths for the working fluid, thereby generating a capillary force for stably circulating the working fluid. Since the communicating hole is filled with the grains to decrease the conductance of the communicating hole, a back flow of the working fluid can be prevented. Furthermore, by using the grains, a portion having a complicated shape can easily be filled with the grains to generate a capillary force in the filled portion.

In the present invention, the substrate may comprise two substrate layers so that the flow path of the liquid-phase working fluid and the flow path of the vapor-phase working fluid are formed between the two layers.

In the thermal transport apparatus of the present invention, the communicating hole may be filled with a mixture of a plurality of grains having different gain diameters, and the grain diameters may be selected so that the grains having a second grain diameter are disposed in the spaces between the grains having a first grain diameter.

In this way, when the grains having the second grain diameter are disposed in the spaces between the grains having the first grain diameter, the spaces between the grains can be narrowed to increase the capillary force. Also, the spaces between the grains can easily be controlled by changing the grain diameter of the grains having the second grain diameter to obtain an optimum capillary force.

In the thermal transport apparatus of the present invention, the communicating hole may be filled with a plurality of grains having different grain diameters in such a manner that each group of the grains having a common grain diameter forms a layer, and the grain diameter of the layer decreases in the direction nearer to the wick member.

In this construction, the communicating hole is filled with a plurality of grains having different grain diameters so that the number of spaces between the grains deceases in the direction nearer to the wick member, and thus the conductance decreases in this direction to promote a movement of the working fluid in the direction. Also, the conductance is low at the outlet of the communicating hole, and thus a back flow of the working fluid can be prevented.

In the thermal transport apparatus of the present invention, the wick member may comprise a wick part comprising a group of the grains, and a support part for supporting the group of the grains constituting the wick part.

In this construction, the wick part comprises the grains, and thus the spaces between the grains can easily be controlled to increase the capillary force. Also, in this construction, the wick can easily be formed to comply with the evaporator having a complicated shape, thereby decreasing the production cost.

A method for manufacturing a thermal transport apparatus of the present invention comprises a flow path forming step of forming a flow path of a liquid-phase working fluid and a flow path of a vapor-phase working fluid in a substrate, a communicating hole forming step forming a plurality of communicating holes for communicating the flow path of the liquid-phase working fluid and the flow path of the vapor-phase working fluid with a main surface of the substrate, a grain filling step of filling the communicating hole for communicating the flow path of the liquid-phase working fluid with the main surface of the substrate with grains, a bonding step of bonding a plurality of wick members to the main surface of the substrate so that the wick members communicate with the respective communicating holes, and a supply step of supplying the working fluid to the flow path of the liquid-phase working fluid.

In the present invention, a portion having a complicated shape can easily be filled with the grains to generate a capillary force in the filled portion.

The method for manufacturing the thermal transport apparatus of the present invention may further comprise a welding step of heating the grains filling in each communicating hole to a temperature higher than the softening temperature of the grains to partially weld the surfaces of the adjacent grains between the grain filling step and the bonding step.

Therefore, the grains filling in each communicating hole is heated to a temperature higher than the softening point of the grains to partially weld the adjacent grains, thereby preventing an outflow of the grains from the communicating holes.

### BRIEF DESCRIPTION OF THE DRAWINGS

FIG. 1 is an exploded perspective view showing a thermal transport apparatus according to a first embodiment of the present invention;

FIG. 2 is a perspective view showing an assembled state of the thermal transport apparatus of the first embodiment of the present invention;

FIG. 3A is a plan view showing a flow path pattern formed in a first substrate, FIG. 3B is a sectional view of the first substrate taken along line IIIA-IIIA in FIG. 3A, and FIG. 3C is a sectional view of the first substrate taken along line IIIC-IIIC in FIG. 3A;

FIG. 4A is a plan view of an evaporator wick communicating hole, and FIG. 4B is a sectional view of the evaporator wick communicating hole taken along a line parallel to line IIIA-IIIA in FIG. 3A;

FIG. 5 is a sectional view showing another example of the evaporator wick communicating hole shown in FIG. 4B taken along a line parallel to line IIIA-IIIA in FIG. 3A;

FIG. 6A is a plan view showing an evaporator wick communicating hole of a thermal transport apparatus according to a second embodiment of the present invention, and FIG. 6B a sectional view showing the evaporator wick communicating hole taken along a line parallel to line IIIA-IIIA in FIG. 3A;

FIG. 7A is a plan view showing an evaporator wick communicating hole of a thermal transport apparatus according to a third embodiment of the present invention, and FIG. 7B a sectional view showing the evaporator wick communicating hole taken along a line parallel to line IIIA-IIIA in FIG. 3A;

FIG. 8 is a sectional view showing an evaporator wick communicating hole in which adjacent grains are partially welded by heating;

FIG. 9 is an exploded perspective view showing a thermal transport apparatus according to a fourth embodiment of the present invention;

FIG. 10A is a plan view showing an evaporator, and FIG. 10B is a sectional view of the evaporator taken along line XB-XB in FIG. 10A; and

FIG. 11 is an exploded perspective view of an example of a thermal transport apparatus.

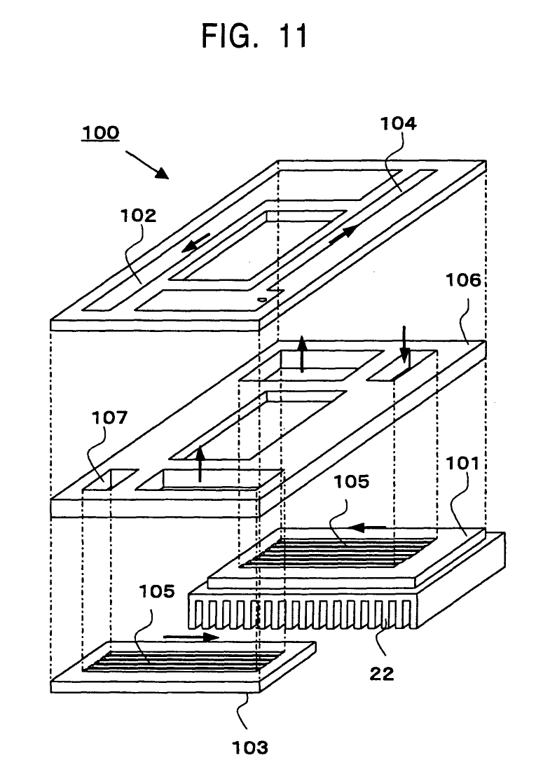

### DESCRIPTION OF THE PREFERRED EMBODIMENTS

Embodiments of the present invention will be described below with reference to the drawings.

First Embodiment

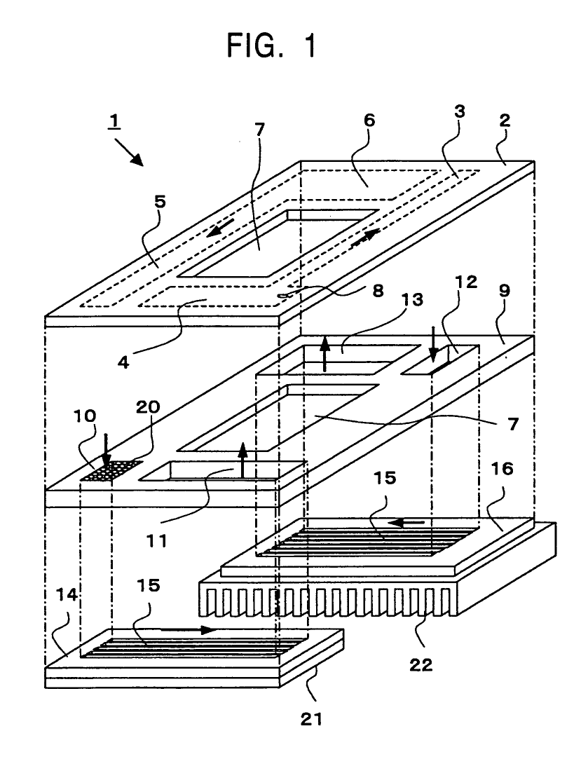

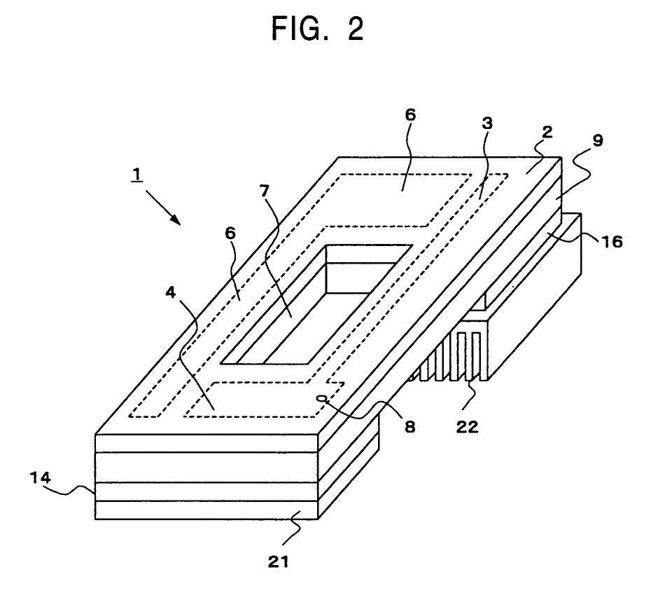

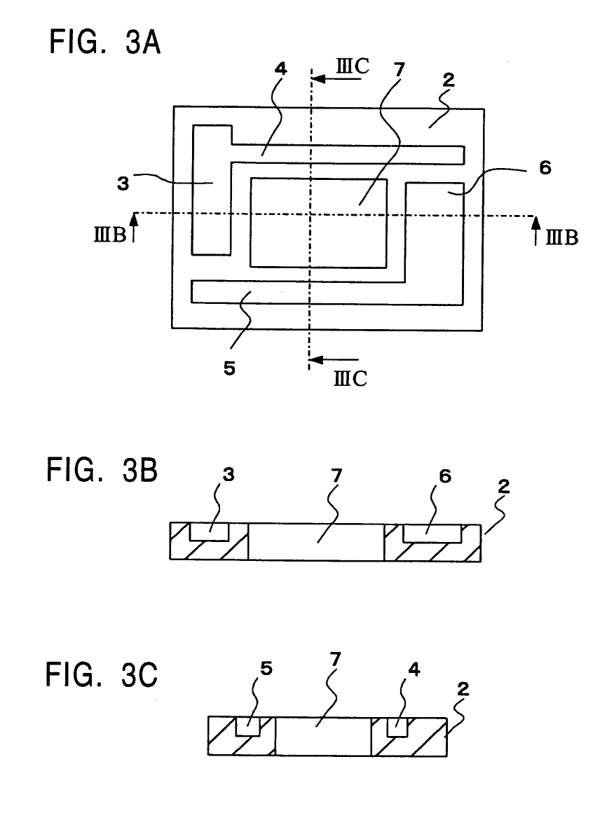

FIG. 1 is an exploded perspective view of a thermal transport apparatus 1 according to a first embodiment of the present invention, and FIG. 2 is a perspective view of an assembled state of the thermal transport apparatus 1. FIG. 3A is a plan view showing a flow path pattern formed in a first substrate 2, FIG. 3B is a sectional view of the first substrate 2 taken along line IIIA-IIIA in FIG. 3A, and FIG. 3C is a sectional view of the first substrate 2 taken along line IIIC-IIIC in FIG. 3A. In each of the drawings, flow directions of a working fluid are shown by arrows.

As shown in FIG. 1, the thermal transport apparatus 1 mainly comprises the first substrate 2, a second substrate 9, an evaporator 14 for evaporating the working fluid, and a condenser 16 for condensing the working fluid.

As shown in FIG. 3, a vapor-phase path 3, an evaporation part 4 communicating with the vapor-phase path 3, a liquid-phase path 5, and a condensation part 6 communicating with the liquid-phase path 5 are provided in a surface of the first substrate 2. Also, a vapor-liquid phase separating hole 7 is formed at the center of the first substrate 2, for separating the vapor-phase path 3 from the liquid-phase path 5 to suppress heat transfer between both paths. Furthermore, a working fluid supply hole 8 is formed in the other surface of the first substrate 2 to communicate with the evaporation part 4. The working fluid supply hole 8 is closed with a cover at all times except when the working fluid is supplied.

The second substrate 9 has an evaporator wick communicating hole 10, an evaporation part communicating hole 11, a condenser wick communicating hole 12, a condensation part communicating hole 13, and a vapor-liquid phase separating hole 7. The evaporator wick communicating hole 10 is a communicating hole through which the liquid working fluid in the liquid-phase path 5 passes when it flows into a wick 15 of the evaporator 14. The evaporation part communicating hole 11 is a communicating hole through which a vapor of the working fluid evaporating in the wick 15 of the evaporator 14 passes when it flows into the evaporation part 4. The condenser wick communicating hole 12 is a communicating hole through which a vapor of the working fluid in the vapor-phase path 3 passes when it flows into the wick 15 of the condenser 16. The condensation part communicating hole 13 is a communicating hole through which the working fluid liquefied in the wick 15 of the condenser 16 passes when it flows into the condensation part 6. The vapor-liquid phase separating hole 7 is formed at a position corresponding to the vapor-liquid phase separating hole 7 of the first substrate 2, for separating the vapor-phase path 3 from the liquid-phase path 5 to suppress heat transfer between both paths.

Each of the first and second substrates 2 and 9 is made of, for example, glass, a synthetic resin such as polyimide, Teflon (registered trade name), PDMS (polydimethylsiloxane), or the like, because with excessively high thermal conductivity, heat diffusion in each substrate adversely affects the efficiency of thermal transport of the thermal transport apparatus 1. The groove of each of the vapor-phase path 3, the evaporation part 4, the liquid-phase path 5 and the condensation part 6, which are provided in the first substrate 2, is formed by, for example, sand blasting, RIE (dry etching), wet etching, UV light etching, laser etching, proton light etching, electron beam lithography etching, micro molding, or the like.

In bonding the first and second substrates 2 and 9 together by an anode coupling method, an amorphous silicon hydride (a-Si:H) film of 50 nm thick is formed on the bonding surface of the first substrate 2. However, the bonding method is not limited to this, and for example, adhesive bonding using a resin as an adhesive, pressure bonding such as thermal compression bonding, weld bonding such as laser welding, or the like may be used.

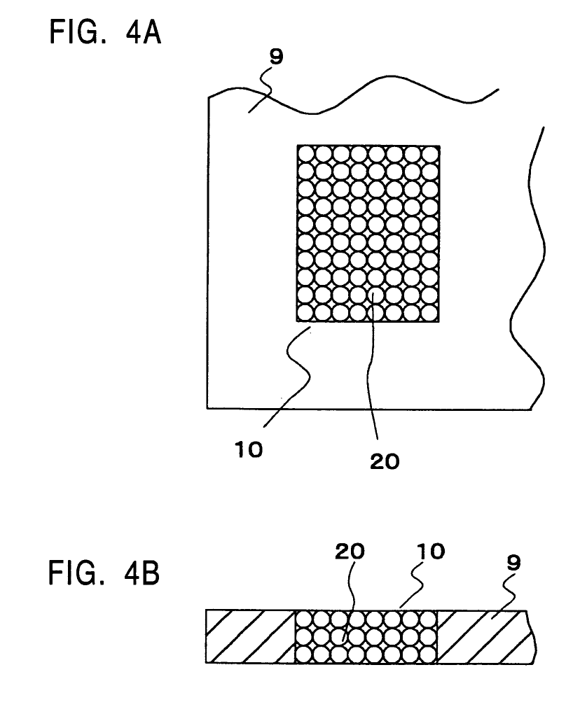

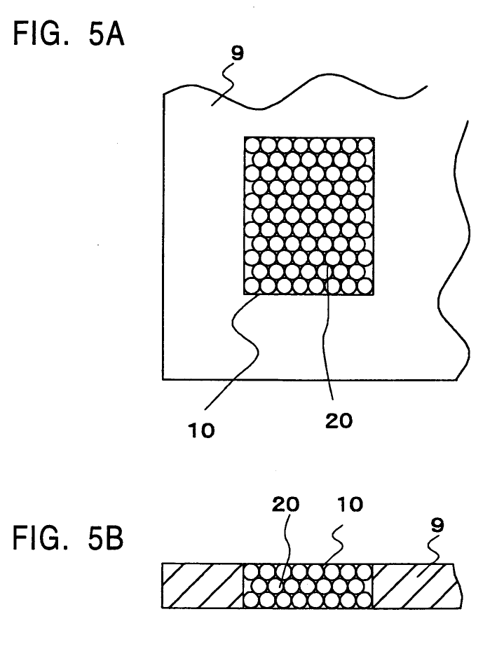

As shown in FIGS. 4A and 4B, the evaporator wick communicating hole 10 formed in the second substrate 9 is filled with a plurality of grains 20. FIG. 4A is a plan view of the evaporator wick communicating hole 10, and FIG. 4B is a sectional view of the evaporator wick communicating hole 10 taken along a line parallel to line IIIA-IIIA in FIG. 3A. The evaporator wick communicating hole 10 is filled with the grains 20 having substantially the same grain diameter. FIG. 4B shows an example in which the hole 10 is regularly filled with the grains 20 with a pitch equal to the grain diameter of the grains 20. However, the filling state is not limited to this, and the hole 10 may be filled with the grains 20 in a staggered arrangement, as shown in FIG. 5. The filling grains 20 are made of, for example, glass, a synthetic resin, a metal, ceramic, or the like, which has hydrophobicity. Although the grains 20 are preferably spherical, the shape of the gains 20 is not limited to this, and the grains 20 may have any shape as long as spaces are formed between the grains 20 in filling.

The evaporator 14 is preferably made of a material having a low density and high thermal conductivity, for example, silicon or the like. The material is not limited to this, and for example, a metal such as Cu, Al, Ni, Au, Ag, Pt, or the like, or a material having the same degree of thermal conductivity as that of a metal, for example, a conductive polymer or ceramic, may be used. The irregular wick 15 is formed on a surface of the evaporator 14. The grooves formed by irregularities of the wick 15 of the wick 15 have a width smaller than the grain diameter of the grains 20 filling in the evaporator wick communicating hole 10. After the evaporation wick communicating hole 10 is filled with the grains 10, the evaporator 14 is bonded to the second substrate 9 by the anode coupling method to cover the evaporator wick communicating hole 10 and the evaporation part communicating hole 11 so that the surface having the wick 15 formed therein faces the second substrate 9. Since the grooves of the wick 15 have a width smaller than the grain diameter of the grains 20, the grains 20 do not flow to the wick 15. As shown in FIG. 2, an electronic apparatus 21 generating heat, for example, CPU, a graphic chip, a driver IC, or the like, is connected to the other surface of the evaporator 14, for cooling the electronic apparatus 21.

The condenser 16 is preferably made of a material having a low density and high thermal conductivity, for example, silicon or the like. The material is not limited to this, and for example, a metal such as Cu, Al, Ni, Au, Ag, Pt, or the like, or a material having the same degree of thermal conductivity as that of a metal, for example, a conductive polymer or ceramic, may be used. The irregular wick 15 is formed on a surface of the condenser 16. Also, a radiating fin 22 is provided on the other surface of the condenser 16, for radiating heat to the outside by thermal transfer. The condenser 16 is bonded to the second substrate 9 by the anode bonding method so as to cover the condenser wick communicating hole 12 and the condensation part communicating hole 13 so that the surface having the wick 15 formed therein faces the second substrate 9.

Furthermore, for example, water as the working fluid is supplied to the thermal transport apparatus 1 through a working fluid supply hole provided in the first substrate 2 in a vacuum atmosphere. Besides water, other fluids having a boiling point, an antibacterial activity, etc. which satisfy a design of a refrigerant or the heat transport apparatus 1, for example, ethanol, methanol, propanol (including isomers), ethyl ether, ethylene glycol, Florinate, or the like, may be used as the working fluid.

Next, the operation of the thermal transport apparatus 1 will be described below.

The liquid working fluid flowing through the liquid-phase path 5 toward the evaporator wick communicating hole 10 permeates into the micro holes between grains filling in the evaporator wick communicating hole 10 by a capillary force, and flows into the wick 15 of the evaporator 14. The liquid working fluid flowing into the wick 15 spreads over the entire region of the wick 15 of the evaporator 14 by the capillary force of the wick 15. The liquid working fluid spreading over the entire region of the wick 15 is evaporated by heat generated from the electronic apparatus 21 connected to the other surface of the evaporator 14 apart from the surface having the wick 15 provided therein. The heat generated from the electronic apparatus 21 transfers through the evaporator 14 by heat conduction to the wick 15 and is transmitted to the working fluid from the surface of the wick 15 by heat conduction. A vapor of the working fluid passes through the vapor-phase path 3 and flows into the condenser 16 through the condenser wick communicating hole 12 formed in the second substrate 9. In the condenser 16, the heat of the vapor of the working fluid is partially absorbed to again liquefy the working fluid. The heat absorbed from the working fluid is emitted to the outside from the radiating fin 22 provided on the condenser 16 by heat conduction. The liquefied working fluid flows toward the condensation part 6 by a capillary force through the micro spaces of the wick 15 of the condenser 16, and further flows from the condensation part 6 to the evaporator wick communicating hole 10 through the liquid-phase path 5. The series of heat transport is repeatedly performed in the thermal transport apparatus 1.

In the thermal transport apparatus 1 of the first embodiment, the evaporator wick communicating hole 10 is filled with grains 20 to form a plurality of micro flow paths for the working fluid, thereby generating a capillary force. Therefore, the working fluid can be stably flowed from the liquid-phase flow path 5 to the wick 15 of the evaporator 14. Also, since the evaporator wick communicating hole 10 is filled with the grains 20, conductance in the evaporator wick communicating hole 10 can be decreased to prevent a back flow of the working fluid, which evaporates in the evaporator 14, from the evaporator wick communicating hole 10 to the liquid-phase path 5. Furthermore, by using the grains 20, a portion having a complicated shape, which makes it difficult to form the portion by using a porous sintered metal or glass fiber for generating a capillary force, can be easily filled with the grains 20, and a capillary force can be generated in the filled portion.

Therefore, in the thermal transport apparatus 1 of the first embodiment, a flow path of the working fluid, which can produce a capillary force, can easily be formed by filling the grains 20, thereby achieving a high efficiency of thermal transport.

Second Embodiment

A heat transport apparatus of the second embodiment is the same as the thermal transport apparatus 1 of the first embodiment except that the configuration of the grains 20 filling in the evaporator wick communicating hole 10 is changed. Therefore, the configuration of the grains 20 in the evaporator wick communicating hole 10 according to the second embodiment will be described. The same components as those in the thermal transport apparatus 1 of the first embodiment are denoted by the same reference numerals, and thus a duplicated description thereof is omitted.

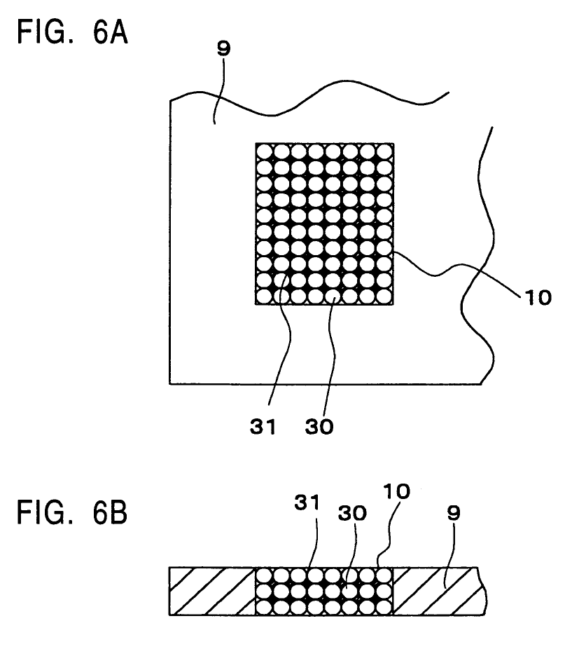

FIG. 6A is a plan view of the evaporator wick communicating hole 10 of the thermal transport apparatus 1 of the second embodiment, and FIG. 6B is a sectional view of the evaporator wick communicating hole 10 taken along a line parallel to line IIIA-IIIA in FIG. 3A. The evaporator wick communicating hole 10 is filled with first grains 30 and second grains 31 filling in the spaces between the first grains 30 and having a smaller diameter than that of the first grains 30. In the first embodiment in which the hole 10 is filled with the grains having a single grain diameter, for example, when the grain diameter is large, the spaces between the grains become large to fail to obtain a sufficient capillary force in some cases. However, as shown in FIG. 6, when the evaporator wick communicating hole 10 is filled with a combination of the first grains 30 and the second grains 31 having a smaller diameter than that of the first grains 30, the spaces between the grains can be made small to further increase the capillary force.

In this way, in the thermal transport apparatus of the second embodiment, the second grains 31 having a smaller grain diameter than that of the first grains 30 are disposed in the spaces formed between a plurality of the first grains 30 to decrease the spaces between the grains, thereby increasing the capillary force. Also, the spaces between the grains can easily be controlled by changing the grain diameter of the second grains 31 to obtain an optimum capillary force.

Third Embodiment

A heat transport apparatus of the third embodiment is the same as the thermal transport apparatus 1 of the first embodiment except that the configuration of the grains 20 filling in the evaporator wick communicating hole 10 is changed. Therefore, the configuration of the grains 20 in the evaporator wick communicating hole 10 according to the third embodiment will be described. The same components as those in the thermal transport apparatus 1 of the first embodiment are denoted by the same reference numerals, and thus a duplicated description thereof is omitted.

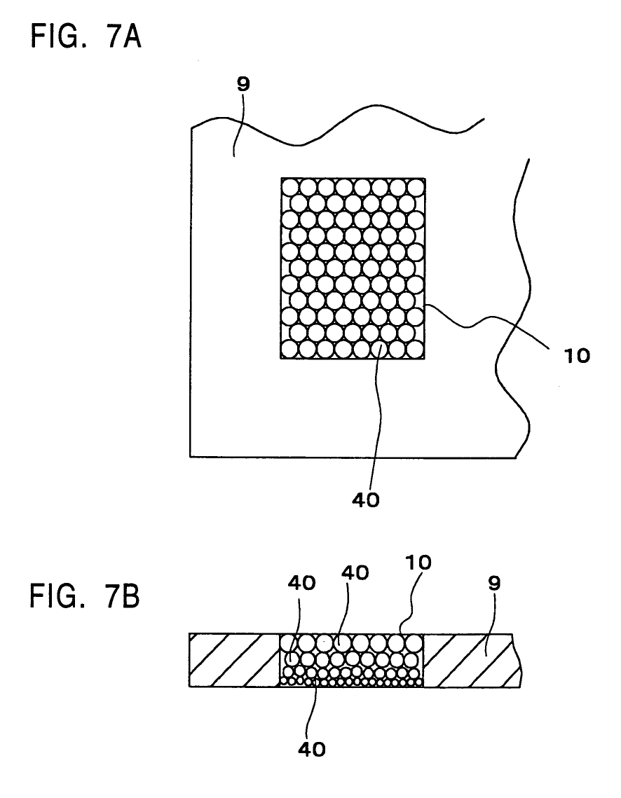

FIG. 7A is a plan view of the evaporator wick communicating hole 10 of the thermal transport apparatus of the third embodiment, and FIG. 7B is a sectional view of the evaporator wick communicating hole 10 taken along a line parallel to line IIIA-IIIA in FIG. 3A. As shown in FIGS. 1 and 7B, the evaporator wick communicating hole 10 is filled with grains 40 having a plurality of grain diameters so that the grain diameter decreases in the direction (the downward direction in the drawing) from the liquid-phase path 5 to the wick 15 of the evaporator 14.

When the grooves of the wick 15 have a smaller width than the grain diameter of the grains 40, the grains 40 filling in the evaporator wick communicating hole 10 do not flow out to the wick 15. However, when the grains 40 having a smaller grain diameter than the width of the grooves of the wick 15 are used for increasing the capillary force, when the grains 40 possibly flow out to the wick 15. Therefore, the grains 40 having a smaller grain diameter than the width of the grooves of the wick 15 are used, the evaporator wick communicating hole 10 can be filled with the grains 40 by the following method.

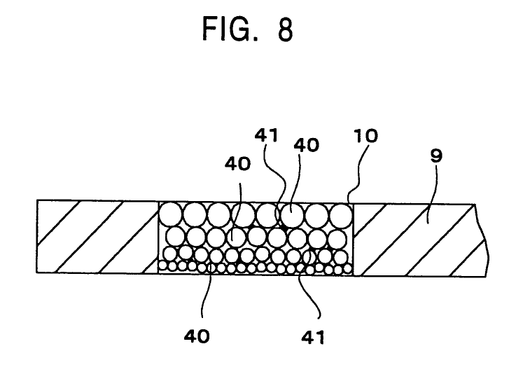

As shown in FIG. 7, the evaporator wick communicating hole 10 is filled with the grains 40 having a plurality of grain diameters so that the grain diameter decreases in the direction from the liquid-phase path 5 to the wick 15 of the evaporator 14, and then heated to a temperature higher than the softening point of the grains 40 for a short time. Although not shown in the drawings, a quartz glass plate is provided at the bottom of the evaporator wick communicating hole 10 filled with the grains 40 so as to prevent the grains from flowing from the evaporator wick communicating hole 10 to the outside during heating. Heating to a temperature higher than the softening point of the grains 40 for a short time can form welded portions 41 to partially weld the surfaces of the adjacent grains 40, as shown in FIG. 8 which is a sectional view of the evaporator wick communicating hole 10. In the method for partially welding the surfaces of the adjacent grains 40 by heating, for example, the second substrate 9 made of heat-resistant glass and having the evaporator wick communicating hole 10 filled with the grains 40 made of soda-lime glass is heated in a furnace to weld the adjacent grains 40.

In the thermal transport apparatus of the third embodiment, the evaporator wick communicating hole 10 is filled with the grains 40 having different grain diameters so that the space between the grains decreases in the direction from the liquid-phase path 5 to the wick 15 of the evaporator 14, and thus conductance decreases in this direction to accelerate a movement of the working fluid in the direction. Also, a portion of the evaporator wick communicating hole 10 near the evaporator 14 has low conductance, and thus the working fluid evaporating in the evaporator 14 can be prevented from flowing back from the evaporator wick communicating hole 10 to the liquid-phase path 5. Furthermore, the grains 40 filling in the evaporator wick communicating hole 10 are heated to a temperature higher than the softening point of the grains 40 for a short time to partially weld the adjacent grains 40, thereby preventing an outflow of the grains 40 from the evaporator wick communicating hole 10.

In the thermal transport apparatus of the third embodiment, therefore, a movement of the working fluid in the evaporator wick communicating hole 10 can be accelerated, and a back flow of the working fluid can be prevented, thereby achieving a high efficiency of thermal transport. Also, an outflow of the grains 40 from the evaporator wick communicating hole 10 can be prevented by welding the adjacent grains 40.

Fourth Embodiment

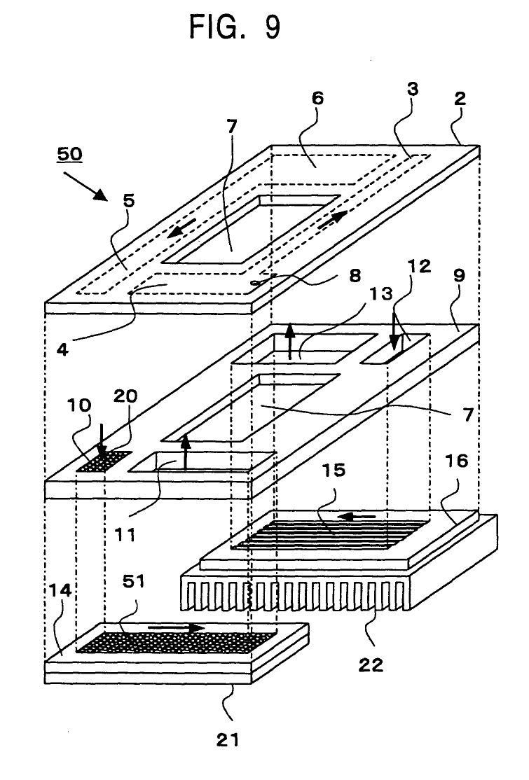

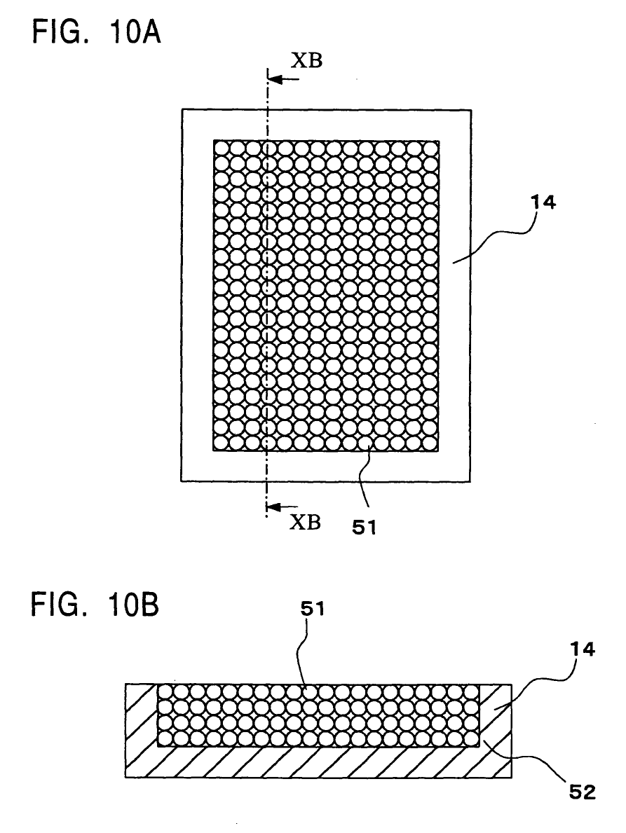

FIG. 9 is an exploded perspective view of a thermal transport apparatus 50 according to a fourth embodiment of the present invention. FIG. 10A is a plan view of an evaporator 14, and FIG. 10B is a sectional view of the evaporator 14 taken along line XB-XB in FIG. 10A. In the drawings, flow directions of the working fluid are shown by arrows.

The thermal transport apparatus 50 of the fourth embodiment is the same as the thermal transport apparatus 1 of the first embodiment except that the wick 15 of the evaporator 14 comprises grains 51. The same components as those of the thermal transport apparatus 1 of the first embodiment are denoted by the same reference numerals, and a duplicated description is omitted.

As shown in FIG. 10, a recess 52 is formed in a surface of the evaporator 14 and is filled with the grains 51. Although FIG. 10 shows a state in which the recess 52 is filled with the grains 51 having a same grain diameter, the recess 52 is not limited to this. For example, as described in the second embodiment, the recess 52 may be filled with first grains and second grains filling in the spaces between the first grains and having a smaller diameter than that of the first grains. Alternatively, as described in the third embodiment, the recess 52 may be filled with grains having a plurality of grain diameters so that the grain diameter decreases in the flow direction of the working fluid, i.e., the direction (the direction shown by an arrow in FIG. 9 showing the evaporator 14) from the side near the evaporator wick communicating hole 10 to the side near the evaporation part 11. Furthermore, as described in the third embodiment, in order to prevent an outflow of the grains 51 from the evaporator 14, a heat-resistant evaporator may be used as the evaporator 14 filled with the grains and heated to a temperature higher than the softening point of the grains 51 to partially weld the surfaces of the adjacent grains 51. The grains 51 used are preferably made of a material having high thermal conductivity, for example, silicon, Cu, Al, or the like, in order to efficiently transmit external heat to the working fluid. However, glass, a synthetic resin, ceramic, or the like may be used.

Although not shown in the drawings, the wick 15 of the condenser 16 may comprise the grains 51 in the same manner as the evaporator 14.

In the thermal transport apparatus 50 of the fourth embodiment, the wick 15 of the evaporator 14 comprises the grains 51 to facilitate the control of the spaces between the grains, thereby increasing the capillary force and achieving a high efficiency of thermal transport. Also, the irregular wick can easily be formed to comply with an evaporator having a complicated shape, thereby decreasing the production cost.

Other Embodiments

The present invention is not limited to the above-described embodiments, and the configuration, materials, etc. can be extended and changed in the scope of the technical idea of the present invention. The technical field of the present invention includes extended and modified embodiments.

Another communicating hole or flow path other than the evaporation wick communicating hole, the evaporator and the condenser can be filled with or equipped with the grains used in the present invention.

As described above, in the present invention, a flow path of a working fluid is filled with a plurality of grains, and thus a capillary force can easily be generated, and can be increased, thereby stably circulating the working fluid in a thermal transport apparatus and achieving a high efficiency of thermal transport. Also, a portion having a complicated shape can be easily filled with grains to generate a capillary force.

What is claimed is:

1. A thermal transport apparatus comprising:
a substrate having a flow path of a liquid-phase working fluid and a path of a vapor-phase working fluid;
a wick member disposed on at least one main surface of the substrate;
a communicating hole provided in the substrate for communicating the flow path of the liquid-phase working fluid of the substrate with the wick member; and
grains filling in the communicating hole.

2. A thermal transport apparatus according to claim 1, wherein the substrate comprises two substrate layers so that the flow path of the liquid-phase working fluid and the flow path of the vapor-phase working fluid are formed between the two layers.

3. A thermal transport apparatus according to claim 1, wherein the communicating hole is filled with a mixture of a plurality of grains having different gain diameters, and the grain diameters are selected so that the grains having a second grain diameter are disposed in the spaces between the grains having a first grain diameter.

4. A thermal transport apparatus according to claim 1, wherein the communicating hole is filled with a plurality of grains having different grain diameters so that each group of the grains having a common grain diameter forms a layer, and the grain diameter of the layer decreases in the direction nearer to the wick member.

5. A thermal transport apparatus according to claim 1, wherein the wick member comprises a wick part comprising a group of the grains, and a base part for supporting the group of the grains constituting the wick part.

6. A method for manufacturing a thermal transport apparatus comprising:
a flow path forming step of forming a flow path of a liquid-phase working fluid and a flow path of a vapor-phase working fluid in a substrate;
a communicating hole forming step forming a first communicating hole for communicating the flow path of the liquid-phase working fluid with a main surface of the substrate and forming a second communicating hole for communicating the flow path of the vapor-phase working fluid with the main surface of the substrate;
a grain filling step of filling the first communicating hole;
a bonding step of bonding a plurality of wick members to the main surface of the substrate so that the wick members communicate with the respective communicating holes; and
a supply step of supplying the working fluid to the flow path of the liquid-phase working fluid.

7. A method for manufacturing a thermal transport apparatus according to claim 6, further comprising a welding step of partially welding the surfaces of the adjacent grains filling in the first communicating hole.
